(19) United States
(12) Patent Application Publication
(10) Pub. No.: US 2019/0300202 A1
(43) Pub. Date: Oct. 3, 2019

(54) METHOD AND SYSTEM FOR RETRIEVING A PACKAGE DELIVERED BY AN UNMANNED AERIAL VEHICLE

(71) Applicant: Walmart Apollo, LLC, Bentonville, AR (US)

(72) Inventors: Donald R. HIGH, Noel, MO (US); Robert CANTRELL, Herndon, VA (US); Brian MCHALE, Oldham (GB)

(73) Assignee: Walmart Apollo, LLC, Bentonville, AR (US)

(21) Appl. No.: 16/359,407

(22) Filed: Mar. 20, 2019

Related U.S. Application Data
(60) Provisional application No. 62/649,961, filed on Mar. 29, 2018.

(51) Int. Cl. B64F 1/36; G05B 15/02; B65G 11/02; B64F 1/32

(52) U.S. Cl. CPC B64F 1/368; G05B 15/02; B64C 39/024; B64F 1/32; B65G 2201/0235; B65G 11/023

(57) ABSTRACT

A system and a method for retrieving a package delivered by an Unmanned Aerial Vehicle (UAV). The system includes a receiving structure mounted to and extending from a wall of a building, the receiving structure being configured to receive the package delivered by the UAV; and a transport system configured to transport the package from the receiving structure located outside of the building to a location inside of the building. The receiving structure includes a platform configured to support a weight of the UAV and the package carried by the UAV, and a trap door mounted to the platform configured to open and close an opening leading to the transport system.

### CROSS-REFERENCE TO RELATED APPLICATIONS

The present patent application claims priority benefit to U.S. Provisional Patent Application No. 62/649,961 filed on Mar. 29, 2018, the entire content of which is incorporated herein by reference.

### BACKGROUND

### 1. Technical Field

The present disclosure relates generally to unmanned vehicles transport and more specifically to a method and system for retrieving a package delivered by an unmanned aerial vehicle (UAV).

### 2. Introduction

Autonomous vehicles, such as Unmanned Aerial Vehicles (UAVs), commonly known as drones, are becoming ubiquitous. UAVs are increasingly used in aerial imagery and photography, for surveillance, commercial applications, real-estate applications, scientific applications, equipment inspections, agricultural applications, military applications, and recreational applications. UAVs are also contemplated as transport vehicles for delivering goods such as packages. An UAV is an aircraft that is piloted without a human pilot aboard the aircraft. The UAV can be operated using a remote control device by a human operator. The UAV can also be operated autonomously by an onboard programmed or programmable computer(s) programmed to execute a specific series of commands or instructions to control the UAV.

It is desirable to be able to deliver goods (e.g., one or more packages) using a UAV to a building for subsequent retrieval by a person in the building. However, the current methods or systems to retrieve a package delivered by a UAV have inadequacies.

Therefore, there remains a need for a novel system and method for retrieving a package delivered by an UAV to a building (e.g., a house, residential building, office building, or other building).

### SUMMARY

An aspect of the present disclosure is to provide a system for retrieving a package delivered by an Unmanned Aerial Vehicle (UAV). The system includes a receiving structure mounted to and extending from a wall of a building, the receiving structure being configured to receive the package delivered by the UAV; and a transport system configured to transport the package from the receiving structure located outside of the building to a location inside of the building. The receiving structure includes a platform configured to support a weight of the UAV and the package carried by the UAV, and a trap door mounted to the platform configured to open and close an opening leading to the transport system.

Another aspect of the present disclosure is to provide a method for receiving a package delivered by an Unmanned Aerial Vehicle (UAV). The method includes receiving a package carried and delivered by the UAV on a receiving structure mounted to and extending from a wall of a building, the receiving structure comprising a platform configured to support a weight of the UAV and the package carried by the UAV, and a trap door mounted to the platform configured to open and close an opening leading to a transport system. The method also includes opening the trap door upon sensing by a sensor that the package is deposited on the platform or upon receiving a signal from the UAV to open the trap door; and transporting the package by the transport system from the receiving structure located outside of the building to a location inside of the building.

Additional features and benefits of the disclosure will be set forth in the description which follows, and in part will be obvious from the description, or can be learned by practice of the herein disclosed principles. The features and benefits of the disclosure can be realized and obtained by means of the instruments and combinations particularly pointed out in the appended claims. These and other features of the disclosure will become more fully apparent from the following description and appended claims, or can be learned by the practice of the principles set forth herein. It is to be expressly understood, however, that the drawings are for the purpose of illustration and description only and are not intended as a definition of the limits of the disclosure.

### BRIEF DESCRIPTION OF THE DRAWINGS

FIG. 1A is a schematic front view of a system for retrieving a package delivered by a UAV, according to an embodiment of the present disclosure;

FIG. 1B is a schematic lateral view of the system for retrieving the package delivered by the UAV, according to an embodiment of the present disclosure;

FIG. 2 is a schematic front view of a system for retrieving a package delivered by a UAV, according to another embodiment of the present disclosure; and

FIG. 3 shows a block diagram of a delivery system including a system for retrieving a package, according to an embodiment of the present disclosure.

### DETAILED DESCRIPTION

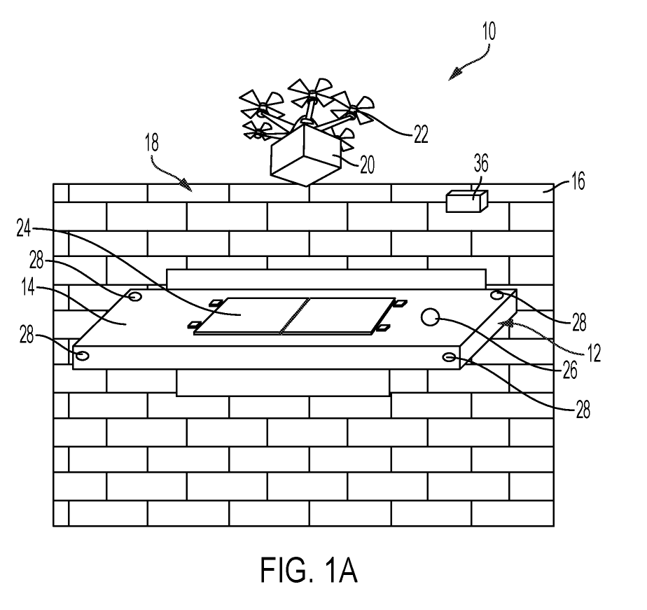

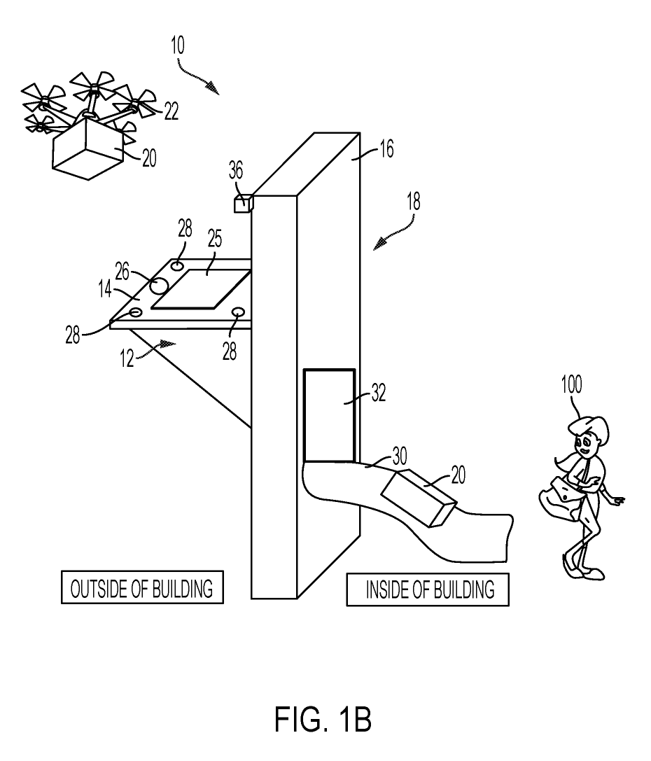

FIG. 1A is a schematic front view of a system 10 for retrieving a package 20 delivered by an autonomous vehicle, such as a UAV 22, according to an embodiment of the present disclosure. FIG. 1B is a schematic lateral view of the system 10 for retrieving the package 20 delivered by the UAV 22, according to an embodiment of the present disclosure. The system 10 includes a receiving structure 12 having a platform 14. In an embodiment, as shown in FIGS. 1A and 1B, the receiving structure 12 is configured as a shelf that extends or projects substantially horizontally from a vertical wall 16 of a building 18 (a house, a residential building, an office building, a factory building, etc.). The receiving structure 12 is located outside of the building 18. The receiving structure 12 (e.g., shelf) is configured to receive the package 20 carried and delivered by the UAV 22. In an embodiment, the receiving structure 12 is a solid structure. For example, the receiving structure 12 can be constructed from any building material, including, but not limited to, concrete, wood, metal, plastic, a composite material, or any combination of these materials.

In an embodiment, the receiving structure 12 (e.g., shelf) can be further configured (i.e., provided large enough and structurally strong enough) to support a weight of the UAV 22 and package 20 that lands on top of the receiving structure 12. The platform 14 of the receiving structure 12 can provide a landing/take-off zone for the UAV 22. As shown in FIG. 1B, the system 10 further includes a transport system 30 configured to transport the package 20 from the receiving structure 12 located outside of the building 18 to a location inside of the building 18. In an embodiment, the UAV 22 can land on the platform 14 of the receiving structure 12 securely as an emergency stop without interfering with regular operations, or as a planned stop to deliver the package 20 to an intended recipient 100 via the transport system 30 connected to the receiving structure 12. In this way, the UAV 22 carrying the package 20 can land on, take-off from, and/or drop off the package 20 on the platform 14 of the receiving structure 12 safely without imperiling the recipient 100 of the package 20 as the recipient 100 is inside the building 18.

In an embodiment, in addition to the platform 14, the receiving structure 12 also includes a trap door 24 (shown in FIG. 1A) mounted to the platform 14. The receiving structure 12 also includes a frame, the frame defining an opening 25 therein (shown in FIG. 1B). The trap door 24 may be mounted to the frame and/or to the platform 14 of the receiving structure 12. The trap door 24 is configured to open and close the opening 25 leading to the transport system 30. For example, the package 20 carried by the UAV 22 can be released onto the trap door 24 that opens to the opening 25 leading to the transport system 30 such as a chute or slide system, a conveyor, an elevator, or an Automatic Guided Vehicle (AGV) system. Although the transport system 30 depicted in FIG. 1B is a chute or slide system, as it can be appreciated, various other systems, including using an AGV system, an elevator system or a conveyor system can also be used for transporting the package 20 from the platform 14 of the receiving structure 12 to a location inside of the building 18. For example, after the UAV 22 releases the package 20 on the trap door 24, sensors provided on the receiving structure 12 can detect the presence of the package 20 and a release mechanism is actuated to open the trap door 24. This allows the package 20 to fall through the opening 25 into the transport system 30 (e.g., chute, conveyor, elevator, etc.) which carries the package 20 via an opening 32 in the wall 16 to the recipient 100 at a location inside of the building 18.

In an embodiment, the trap door 24 can be a hinged door, a sliding door, or any other type of door. For example, FIG. 1A depicts a hinged door. However, a sliding door or an iris-type door can also be used. The trap door 24 can be spring-loaded or actuated by an actuator or motor. Various types of sensors can be used to detect the presence of package 20 on the platform 14 of the receiving structure 12. For example weight sensors can be used for detecting the package 20 on the platform 14. Alternatively or in addition, a camera or optical sensors (e.g., laser beam sensor) can also be used to detect the package 20 on the receiving structure 12. In the case of optical sensors, one or more lasers can be used to project laser beams onto optical sensors and when the package 20 blocks the laser beam or beams, the presence of the package is detected and the trap door 24 is opened. In another embodiment, the UAV 22 may also communicate with the opening mechanism of the trap door 24 and send a signal to open the trap door 24 automatically upon arrival of the UAV 22 to the receiving structure 12. In this way, the package 20 can be transported to the interior of the building 18 upon its arrival at the receiving structure 12. This will prevent the package from being damaged by weather elements, such as rain, snow, etc.

In an embodiment, the receiving structure 12 may also be provided with one or more light indicators 26 to indicate that the package 20 is delivered. In an embodiment, the platform 14 on the building structure 12 can provide a large visual target to be “seen” by the UAV 22 during flight. However, to aid the UAV 22 in locating the receiving structure 12, one or more location lights 28 can also be provided. In this way even in less than optimal visibility conditions, the UAV 22 can use its on-board cameras and/or position sensors to locate the lights 28 and thus the platform 14 of the receiving structure 12. The one or more lights 28 can be blinking lights or steady lights. In another embodiment, one or more frequency beacons (e.g., radiofrequency beacons) can be used instead of or in addition to the one or more lights 28. A communication signal between the one or more frequency beacons and a sensor on-board of the UAV 22 provide for precise location by the UAV 22 of the platform 14 of the receiving structure 12.

In an embodiment, a micro-weather monitoring station 36 can be provided in the vicinity of the receiving structure 12. For example, the micro-weather monitoring station 36 can be mounted to wall 16 of the building 18. The micro-weather monitoring station 36 can be configured to monitor weather conditions such as wind or rain fall at or in the vicinity of the receiving structure 12 and provide information on the local weather conditions to an approaching UAV 22. For example, the micro-weather monitoring station 36 can measure the wind in the vicinity of the receiving structure 12 and if the wind reaches a certain level, the micro-weather monitoring station 36 can send the wind information (strength, orientation, etc.) to the UAV 22. In this way, the UAV 22 can use this information to perform adequate adjustments to its engines and orientation during its approach phase to the receiving structure 12. For example, if the wind is strong and does not allow for a safe delivery of the package 20, the UAV 22 may abort the delivery of the package 20 and pull away from the receiving structure 12 to prevent damage to the UAV 22 and/or its cargo package 20.

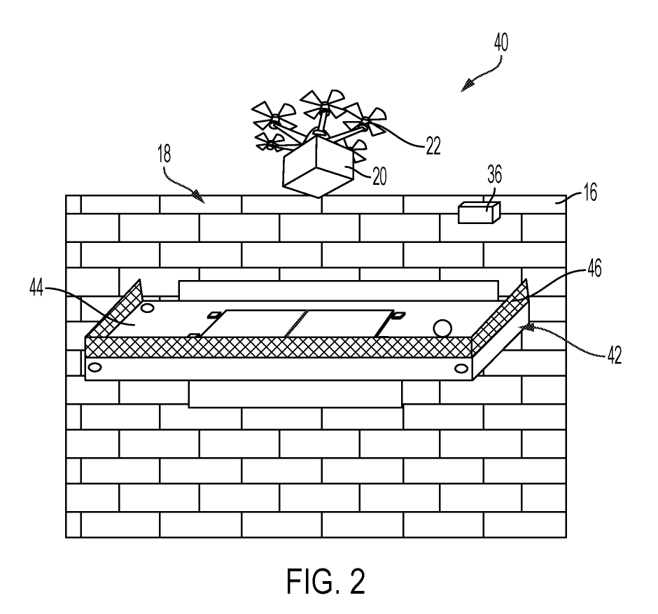

FIG. 2 is a schematic front view of a system 40 for retrieving a package 20 delivered by a UAV 22, according to another embodiment of the present disclosure. The system 40 includes a receiving structure 42 having a platform 44. The system 40 shown in FIG. 2 is similar in many aspects to the system 10 shown in FIGS. 1A and 1B. Therefore, similar features will not be further described. The embodiment shown in FIG. 2 contains many of the aspects described above with respect to FIGS. 1A and 1B. However, in the system shown in FIG. 2, the receiving structure 42 instead of being constructed mainly as a solid structure as in the receiving structure 12 in FIGS. 1A and 1B, the receiving structure 42 in addition to the solid portion platform 44, also includes a soft portion 46. The soft portion 46 may include a net, a canvas, or both. The soft portion 46 can be configured to retain the package 20 and thus prevent the package from potentially falling from the structure 42. The soft portion 46 can be provided at a periphery of the platform 44 and can be arranged vertically relative the platform 44 (as depicted in FIG. 2) or horizontally relative to the platform 44, or any angle therebetween. The soft portion 46 can be provided with desired dimensions (e.g., width and/or height) so as to retain the package 20 in case the package 20 misses the platform 44.

As it can be appreciated from the above paragraphs, there is also provided a method for receiving the package 20 delivered by the Unmanned Aerial Vehicle (UAV) 22. The method includes receiving the package 20 carried and delivered by the UAV 22 on the receiving structure 12 mounted to and extending from the wall 16 of the building 18. The receiving structure 12 includes the platform 14 configured to support a weight of the UAV 22 and the package 20 carried by the UAV 22, and a trap door 25 mounted to the platform 14 configured to open and close the opening 25 leading to the transport system 30. The method further includes opening the trap door 24 upon sensing by a sensor that the package 20 is deposited on the platform 14 or upon receiving a signal from the UAV to open the trap door, and transporting the package by the transport system 30 from the receiving structure 12 located outside of the building 18 to a location inside of the building 18.

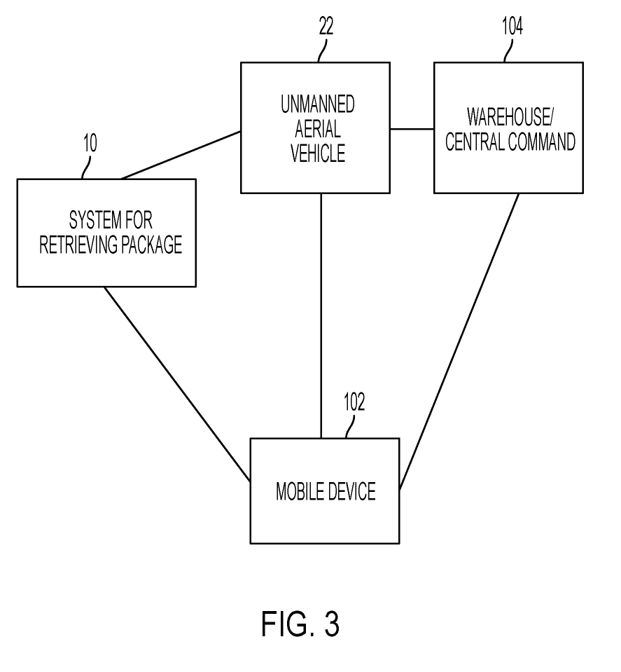

FIG. 3 shows a block diagram of a delivery system including system 10 for retrieving package 20, according to an embodiment of the present disclosure. System 10 and/or associated components of system 10 may communicate with the UAV 22 to receive information on package delivery, receive instructions on deployment, receive instructions of storage, and/or send confirmation of package receipt. The system 10 and/or associated components may further communicate with a consumer's mobile device 102 to receive information on package delivery, receive instructions on deployment, receive instructions of storage, and send confirmation of package receipt. The UAV 22 may communicate with the consumer's mobile device 102 to send or receive information on package delivery, send or receive instructions on deployment, send or receive instructions of storage, and send or receive confirmation of package receipt. The UAV 22 and/or the mobile device 102 may communicate with a warehouse 104 to send or receive information on package delivery, and send or receive confirmation of package receipt. The sensor(s), release device(s), controller(s), communication device(s), and/or motion device(s) of system 10 may send and receive signals with the UAV 22 and the consumer's mobile device 102.

In an embodiment, when UAV 22 is scheduled to deliver package 20 to a consumer, the system 10 may be prepared for receiving the package 20 on the receiving structure 12 (shown in FIGS. 1A, 1B and 2). For example, when the UAV 22 is near the delivery location, for example, within about a mile or less of the receiving structure 12, the UAV 22 may communicate with the system 10 and/or the consumer's mobile device 102. The UAV 22 may send a signal to the system 10 and/or the consumer's mobile device 102 with instructions to the system 10, for example, to open the trap door 24.

In an embodiment, the UAV 22 may communicate with the system 10 to ensure proper alignment of the package 20 to the receiving structure 12 (e.g., proper alignment of the package 20 with the opening 25 under the trap door 24). The UAV 22 may also communicate with the system 10 to ensure that no animals (e.g., birds) are located on the receiving structure 12. The UAV 22 may also receive local weather conditions information from the micro-weather station 36 near the receiving structure 12 so as to prepare to make proper adjustments to its engines and orientation during the UAV 22 approach phase to the receiving structure 12. Once the package 20 is aligned within the receiving structure 12, the delivery mechanism of the UAV 22 may lower and release the package onto the receiving structure 12. In an embodiment, the UAV 22 may land on the receiving structure 12 before releasing the package 20. In another embodiment, the UAV 22 may simply drop the package 20 on the receiving structure 12 without landing on the receiving structure 12. The receiving structure 12 may sense the package 20 has been delivered and released from the UAV 22, for example by sensing an increase in load on the receiving structure 12, or by using optical or other types of sensors. The system 10 may communicate to the UAV 22 or to the consumer's mobile device 102 confirming package delivery.

After delivery of the package 20 to the receiving structure 12 and the package 20 is transported by the transport system 30 (shown in FIG. 1B), the consumer 100 may retrieve the package 20 inside the building 18. The system 10 of the present disclosure may allow for delivery of packages to tall buildings, such as high-rise buildings and/or medium-rise buildings, etc. The system 10 may include sensors, communication device(s), and/or controller(s) to confirm alignment of the package 20 from the UAV 22 before release of the package 20 by the UAV 22. This may allow for overhead protection of people or animals located below the receiving structure 12. For example, the package 20 may be delivered to the receiving structure 12 located high up on the building 18, thus avoiding the need for the UAV 22 to land on the ground.

Although the receiving structure 12, 42 is described in the above paragraphs as being mounted to the wall 16 of the building 18, as it must be appreciated the receiving structure 12, 42 can also be provided or mounted on a roof of the building 18. The roof of the building 18 may be inclined or horizontal. In this case also, the receiving structure 12, 42 can be configured to operate in a similar fashion as the above receiving structure 12, 42. In this case, however, upon releasing the package 20 carried by the UAV 22 on the receiving structure 12, 42, the package 20 falls through the opening 25 directly into the transport system 30 (e.g., chute, conveyor, elevator, etc.) at a location inside of the building 18 to be guided to another location inside the building 18 where the user 100 can retrieve the package 20. For example, the package 20 carried by the UAV 22 can be released onto the trap door 24 that opens to the opening 25 leading to the transport system 30 such as a chute or slide system, a conveyor, an elevator, or an Automatic Guided Vehicle (AGV) system that is located inside the building 18.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

Although the embodiments of disclosure have been described in detail for the purpose of illustration based on what is currently considered to be the most practical, it is to be understood that such detail is solely for that purpose and that the present disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

We claim:

1. A system for retrieving a package delivered by an Unmanned Aerial Vehicle (UAV), the system comprising:
a receiving structure mounted to and extending from a wall of a building, the receiving structure being configured to receive the package delivered by the UAV;
a transport system configured to transport the package from the receiving structure located outside of the building, via an opening in the wall, to a location inside of the building,
wherein the receiving structure comprises:
a platform having a top surface configured to support a weight of the UAV and the package carried by the UAV, a bottom surface and an exterior frame defining an opening from the top surface through the bottom surface, the opening leading to the transport system and
a trap door mounted to the platform and configured to open and close the opening leading to the transport system
a sensor configured to detect a presence of the package on the platform of the receiving structure; and
a controller coupled to the sensor to receive a signal from the sensor that the package is on the platform, and to send a signal to open the trap door when the signal is received.

2. The system according to claim 1, further comprising navigation sensors disposed at the receiving structure, the navigation sensors emitting signals indicating a location and identification of the receiving structure.

3. The system according to claim 1, wherein the transport system comprises a slide, a chute, a conveyor, an elevator, or an automated guided vehicle (AGV) system, or any combination thereof.

4. The system according to claim 1, wherein the platform is configured and arranged to provide a landing or take-off area to the UAV.

5. The system according to claim 1, wherein the top surface of the frame is substantially flat and projects substantially horizontally from the wall of the building, and further comprising a barrier extending vertically from and arranged around a periphery of the top surface.

6. The system according to claim 1, wherein the exterior frame and the wall cooperate to define the opening.

7. The system according to claim 1, wherein the trap door is spring loaded or actuated by an actuator or motor.

8. The system according to claim 1, where the transport system comprises one of a slide arranged to receive the package via the trap door, a conveyor arranged to receive the package via the trap door, or an elevator arranged to receive the package via the trap door.

9. The system according to claim 1, wherein the sensor comprises a weight sensor, a camera, an optical sensor, or any combination thereof.

10. The system according to claim 1, wherein the receiving structure further comprises light indicators to indicate that the package is delivered.

11. The system according to claim 1, wherein the receiving structure further comprises one or more location lights, one or more frequency beacons, or both configured to enable the UAV to locate the receiving structure.

12. The system according to claim 1, further comprising a micro-weather monitoring station provided in the vicinity of the receiving structure, the micro-weather monitoring station being configured to monitor weather conditions at or in the vicinity of the receiving structure and provide information on local weather conditions to an approaching UAV.

13. The system according to claim 1, wherein the receiving structure comprises a soft portion to retain the package and prevent the package from potentially falling from the receiving structure.

14. The system according to claim 13, wherein the soft structure, includes a net, or a canvas or both.

15. A method for receiving a package delivered by an Unmanned Aerial Vehicle (UAV), the method comprising:
receiving a package carried and delivered by the UAV on a receiving structure mounted to and extending from a wall of a building, the receiving structure comprising a platform configured to support a weight of the UAV and the package carried by the UAV, and a trap door mounted to the platform configured to open and close an opening leading to a transport system;
opening the trap door upon sensing by a sensor that the package is deposited on the platform or upon receiving a signal from the UAV to open the trap door; and
transporting the package by the transport system from the receiving structure located outside of the building to a location inside of the building.

16. The method according to claim 15, wherein transporting the package comprises sliding the package though a slide, carrying the package using a conveyor, an elevator or an automated guided vehicle (AGV) system, or any combination thereof to the location inside of the building.

17. The method according to claim 15, further comprising prior to opening the trap door sensing a weight of the package using a weight sensor or sensing the package using an optical sensor or camera, or both.

18. The method according to claim 15, further comprising monitoring weather conditions at or in the vicinity of the receiving structure and providing information on local weather conditions to an approaching UAV.
